(19) United States
(12) Patent Application Publication
(10) Pub. No.: US 2012/0081639 A1
(43) Pub. Date: Apr. 5, 2012

(54) LIQUID CRYSTAL DISPLAY DEVICE

(76) Inventors: Guang-Shiung Chao, Renwu Township (TW); Feng-Weei Kuo, Fangliao Township (TW); Li-Chao Chien, Daxi Township (TW); Ra-Bin Li, Guiren Township (TW); Cheng-Chia Wu, Xinzhuang City (TW); Chao-Hui Wu, Kaohsiung City (TW)

(21) Appl. No.: 13/245,356

(22) Filed: Sep. 26, 2011

(30) Foreign Application Priority Data
Sep. 30, 2010 (TW) 099133362

(51) Int. Cl. G02F 1/1335

(52) U.S. Cl. 349/96

(57) ABSTRACT

A liquid crystal display device includes a first polarization plate, a first birefringent film atop the first polarization plate, an optically compensated bend mode (OCB-mode) cell atop the first birefringent film, a refractive film atop the OCB-mode cell, a second birefringent film atop the refractive film, and a second polarization plate atop the second birefringent film. With this structure, any phase retardation of polarized light occurred during the propagation of the polarized light from the first polarization plate to the second polarization plate is compensated by the first birefringent film, the refractive film, and the second birefringent film and a substantially cross-shaped radiation pattern of full viewing angle is obtained in an actual measurement at the light outgoing surface of the liquid crystal display device, proving the liquid crystal display device has effectively improved the problem of restricted viewing angle and provides good optical performance.

### CROSS-REFERENCE TO RELATED APPLICATION

This application claims the benefit of Taiwan Patent Application No. 099133362, filed on Sep. 30, 2010, in the Taiwan Intellectual Property Office the disclosure of which is incorporated herein by reference.

### FIELD OF THE INVENTION

The present invention relates to a liquid crystal display device, and more particularly to a liquid crystal display device that has simple structure and effectively improves the problem of restricted viewing angle.

### BACKGROUND OF THE INVENTION

In a liquid crystal display, electric field is used to drive liquid crystal molecules to thereby achieve the display effect. However, as being affected by a characteristic of birefringence of the liquid crystal molecules, the polarized light passing through the liquid crystal molecules would lose its polarizability to cause many problems, such as restricted viewing angle and dark-state light leakage.

To correct and improve the above-mentioned problems occurred when the polarized light passes through the liquid crystal molecules while maintaining the existing process of preparing a liquid crystal display, one of the widely adopted solutions is to additionally attach an optical compensation film to an outer side of the liquid crystal cell.

Currently, the optical compensation film for the optically compensated bend mode (OCB-mode) cell is usually a compensation film developed by Fuji Photo Film Company. The optical compensation film provided by Fuji includes a discotic liquid crystal layer. Since the optical compensation film using discotic liquid crystal is very expensive, it is not dominant in the market due to the high cost thereof.

There are many published theses regarding the optical compensation film. However, these theses discuss the use of a four-layer or thicker refractive film to solve the optical problem in connection with the OCB-mode cell. It is very difficult to produce, particularly mass-produce, the four-layer or thicker refractive film. All the above-mentioned problems require some good solutions.

It is therefore tried by the inventor to develop a liquid crystal display device to overcome the above-mentioned drawbacks.

### SUMMARY OF THE INVENTION

A primary object of the present invention is to provide a liquid crystal display device that is able to effectively improve the problem of restricted viewing angle.

Another object of the present invention is to provide a liquid crystal display device that has a simple structure.

A further object of the present invention is to provide a liquid crystal display device that can be easily manufactured.

A still further object of the present invention is to provide a liquid crystal display device that can be manufactured at reduced cost.

To achieve the above and other objects, the liquid crystal display device according to a preferred embodiment of the present invention includes a first polarization plate having a first absorption axis; a first birefringent film being provided atop the first polarization plate and having a slow axis; an optically compensated bend mode (OCB-mode) cell being provided atop the first birefringent film and having an alignment direction; a refractive film being provided atop the OCB-mode cell and having a slow axis, and the slow axis of the refractive film and the alignment direction of the OCB-mode cell being orthogonal to each other; a second birefringent film being provided atop the refractive film and having a slow axis, and the slow axis of the second birefringent film and the slow axis of the first birefringent film being orthogonal to each other; and a second polarization plate being provided atop the second birefringent film and having a second absorption axis, and the second absorption axis of the second polarization plate and the first absorption axis of the first polarization plate being orthogonal to each other. With the above structure, any phase retardation of the polarized light occurred as a result of being influenced by the liquid crystal molecules when the polarized light propagates from the first polarization plate to the second polarization plate is compensated by the first birefringent film, the refractive film, and the second birefringent film; and a substantially cross-shaped radiation pattern of full viewing angle is obtained in an actual measurement at the light outgoing surface of the liquid crystal display device. Therefore, the liquid crystal display device has effectively improved the problem of restricted viewing angle and provides good optical performance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a liquid crystal display device according to a first preferred embodiment of the present invention;

FIG. 2 is an assembled side view of the liquid crystal display device according to the first preferred embodiment of the present invention;

FIG. 3 is a conceptual view of a reference coordinate system defined and used in describing the present invention;

FIG. 4 shows an actually measured radiation pattern of the liquid crystal display device according to the first preferred embodiment of the present invention;

FIG. 5 is an exploded perspective view of a liquid crystal display device according to a second preferred embodiment of the present invention; and

FIG. 6 is an assembled side view of the liquid crystal display device according to the second preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

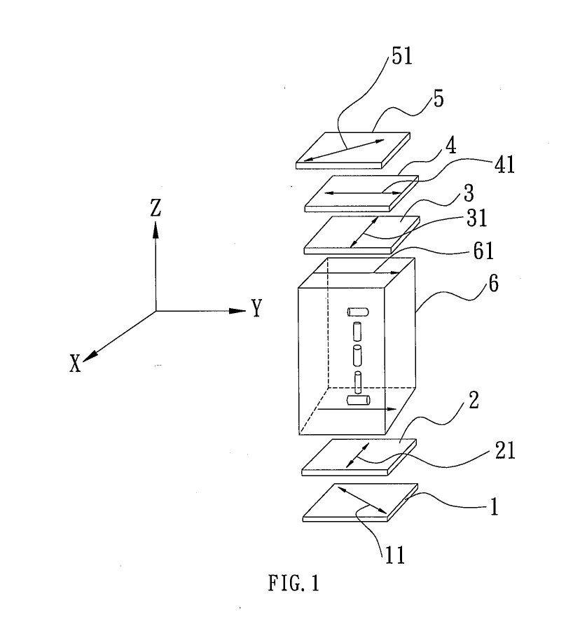

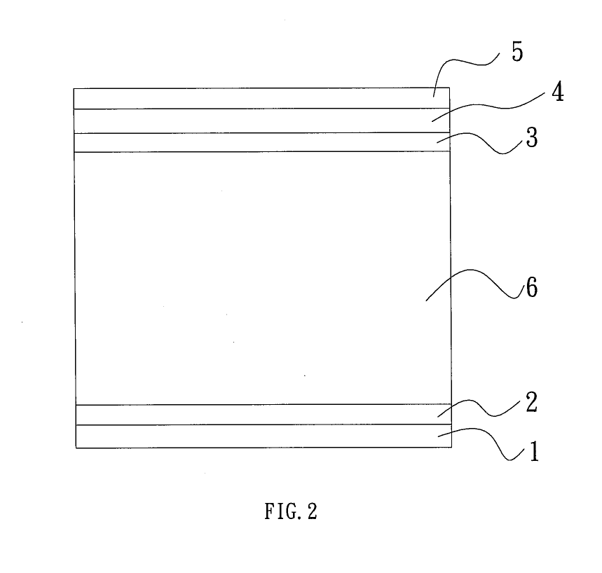

Please refer to FIGS. 1 and 2 that are exploded perspective and assembled side views, respectively, of a liquid crystal display device according to a first preferred embodiment of the present invention. A reference coordinate system is also shown in FIG. 1. The reference coordinate system consists of three orthogonal axes, namely, an x-axis, a y-axis and a z-axis. As shown, the liquid crystal display device in the first preferred embodiment of the present invention includes a first polarization plate 1, a first birefringent film 2, a refractive film 3, a second birefringent film 4, a second polarization plate 5, and an optically compensated bend mode (OCB-mode) cell 6. More specifically, the liquid crystal display device in the first embodiment sequentially includes from bottom to top the first polarization plate 1, the first birefringent film 2 atop the first polarization plate 1, the OCB-mode cell 6 atop the first birefringent film 2, the refractive film 3 atop the OCB-mode cell 6, the second birefringent film 4 atop the refractive film 3, and the second polarization plate 5 atop the second birefringent film 4. The first polarization plate 1 has a first absorption axis 11, and the second polarization plate 5 has a second absorption axis 51. The first absorption axis 11 and the second absorption axis 51 are orthogonal to each other. The first birefringent film 2 has a slow axis 21, and the second birefringent film 4 has a slow axis 41. The slow axis 21 of the first birefringent film 2 and the slow axis 41 of the second birefringent film 4 are orthogonal to each other. The refractive film 3 has a slow axis 31, and the OCB-mode cell 6 has an alignment direction 61. The slow axis 31 of the refractive film 3 and the alignment direction 61 are orthogonal to each other.

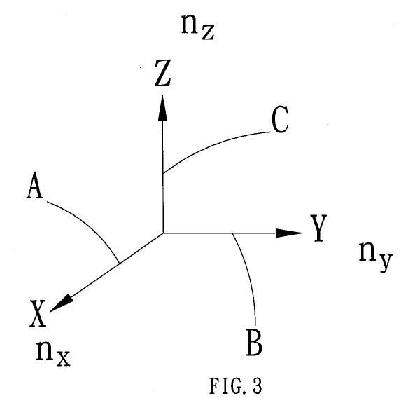

FIG. 3 shows the reference coordinate system defined and used in describing the present invention. Please refer to FIGS. 1, 2 and 3 at the same time. The reference coordinate system consists of three orthogonal axes, namely, an x-axis A, a y-axis B, and a z-axis C. The first birefringent film 2, the refractive film 3, and the second birefringent film 4 each have a refractive index in a direction of the x-axis A, which can be represented by nₓ. Similarly, refractive indexes of each of the first birefringent film 2, the refractive film 3, and the second birefringent film 4 in the directions of y-axis B and z-axis C can be represented by n_{y} and n_{z}, respectively. By representing the refractive indexes in this manner, the birefringent films have the characteristic of nₓ≠n_{y}—n_{z}; and the refractive film 3 has the characteristic of n_{y}=n_{z ≠n}ₓ or n_{y}=nₓ≠n_{z}. While the first and second birefringent films 2, 4 are birefringent films, the refractive film 3 can be either a birefringent film or a simple-refraction film. Meanwhile, the first and the second birefringent films 2, 4 and the refractive film 3 respectively have a thickness-direction phase-difference value Rₜₕ defined as Rₜₕ={(nₓ+n_{y})/2−n_{z}}d, and an in-plane phase-difference value R_{O} defined as R_{O}=(nₓ−n_{y})d. The in-plane phase-difference values R_{O} of the first birefringent film 2, the second birefringent film 4, and the refractive film 3 are preferably ranged between 10 nm and 110 nm, and the thickness-direction phase-difference values Rₜₕ of the first birefringent film 2, the second birefringent film 4, and the refractive film 3 are preferably ranged between 100 mn and 250 nm.

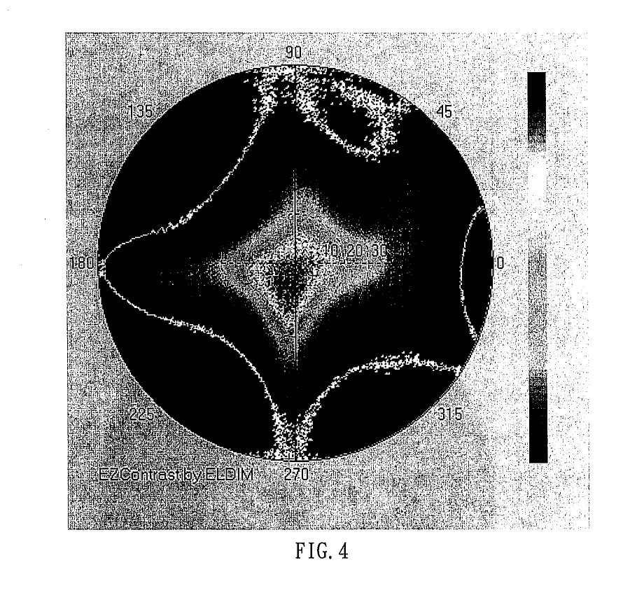

When the liquid crystal display device is in use, light first passes through the first polarization plate 1 and becomes polarized light. The polarized light sequentially passes through the first birefringent film 2, the OCB-mode cell 6, the refractive film 3, the second birefringent film 4, and the second polarization plate 5 to finally go out of the liquid crystal display device. Any phase retardation of the polarized light occurred as a result of being influenced by the liquid crystal molecules when the polarized light propagates from the first polarization plate 1 to the second polarization plate 5 is compensated by the first birefringent film 2, the refractive film 3, and the second birefringent film 4. Please also refer to FIG. 4 that shows an actually measured radiation pattern of the liquid crystal display device according to the first preferred embodiment of the present invention. As shown, a substantially cross-shaped radiation pattern of full viewing angle is obtained when an actual radiation pattern measurement is carried out at a light outgoing surface of the liquid crystal display device of the present invention. From the measuring result, it can be found that the present invention has effectively improved the problem of restricted viewing angle to obtain good optical performance.

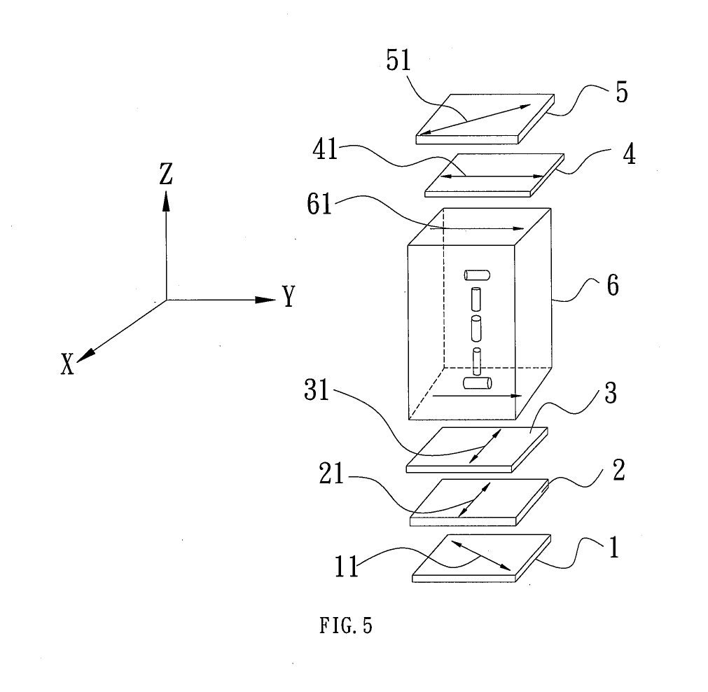

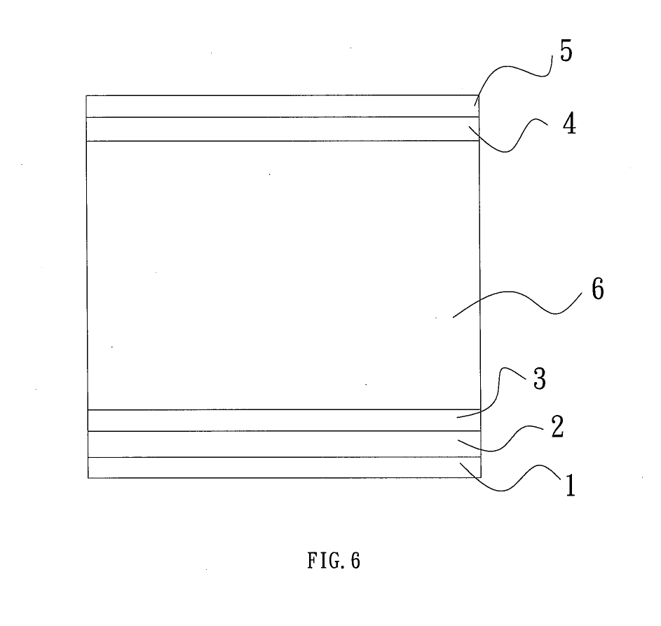

FIGS. 5 and 6 are exploded perspective and assembled side views, respectively, of a liquid crystal display device according to a second preferred embodiment of the present invention. A reference coordinate system is also shown in FIG. 5. The reference coordinate system consists of three orthogonal axes, namely, an x-axis, a y-axis and a z-axis. As shown, the liquid crystal display device in the second preferred embodiment of the present invention includes a first polarization plate 1, a first birefringent film 2, a refractive film 3, a second birefringent film 4, a second polarization plate 5, and an OCB-mode cell 6. The second embodiment is different from the first embodiment in that the refractive film 3 is located atop the first birefringent film 2. That is, the liquid crystal display device in the second embodiment sequentially includes from bottom to top the first polarization plate 1, the first birefringent film 2 atop the first polarization plate 1, the refractive film 3 atop the first birefringent film 2, the OCB-mode cell 6 atop the refractive film 3, the second birefringent film 4 atop the OCB-mode cell 6, and the second polarization plate 5 atop the second birefringent film 4. The first polarization plate 1 has a first absorption axis 11, and the second polarization plate 5 has a second absorption axis 51. The first absorption axis 11 and the second absorption axis 51 are orthogonal to each other. The first birefringent film 2 has a slow axis 21, and the second birefringent film 4 has a slow axis 41. The slow axis 21 of the first birefringent film 2 and the slow axis 41 of the second birefringent film 4 are orthogonal to each other. The refractive film 3 has a slow axis 31, and the OCB-mode cell 6 has an alignment direction 61. The slow axis 31 of the refractive film 3 and the alignment direction 61 are orthogonal to each other.

With the above arrangements, the liquid crystal display device according to the present invention has at least the following advantages of:

(1) Effectively improving the problem of restricted viewing angle:

The liquid crystal display device of the present invention is characterized in having the first birefringent film 2, the refractive film 3 and the second birefringent film 4 separately provided below or above the OCB-mode cell 6. Any phase retardation of the polarized light occurred during the propagation of the polarized light from the first polarization plate 1 to the second polarization plate 5 will be compensated by the first birefringent film 2, the refractive film 3, and the second birefringent film 4. And, a substantially cross-shaped radiation pattern of full viewing angle is obtained when an actual radiation pattern measurement is carried out at the light outgoing surface of the liquid crystal display device of the present invention. From the measuring result, it can be found that the present invention has effectively improved the problem of restricted viewing angle.

(2) Having simple structure:

The liquid crystal display device of the present invention is characterized by providing three layers of refractive films, which are separately located below or above the OCB-mode cell 6. The three layers of refractive films include the first birefringent film 2, the refractive film 3 and the second birefringent film 4. This structure is simple and can be easily manufactured at reduced cost.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A liquid crystal display device, comprising:
a first polarization plate having a first absorption axis;
a first birefringent film being provided atop the first polarization plate and having a slow axis;
an optically compensated bend mode (OCB-mode) cell being provided atop the first birefringent film and having an alignment direction;
a refractive film being provided atop the OCB-mode cell and having a slow axis, and the slow axis of the refractive film and the alignment direction of the OCB-mode cell being orthogonal to each other;
a second birefringent film being provided atop the refractive film and having a slow axis, and the slow axis of the second birefringent film and the slow axis of the first birefringent film being orthogonal to each other; and a second polarization plate being provided atop the second birefringent film and having a second absorption axis, and the second absorption axis of the second polarization plate and the first absorption axis of the first polarization plate being orthogonal to each other.

2. The liquid crystal display device as claimed in claim 1, wherein the first birefringent film, the second birefringent film, and the refractive film respectively have an in-plane phase-difference value R_{O} ranged between 10 nm and 110 nm.

3. The liquid crystal display device as claimed in claim 1, wherein the first birefringent film, the second birefringent film, and the refractive film respectively have a thickness-direction phase-difference value R_{O} ranged between 100 nm and 250 nm.

4. The liquid crystal display device as claimed in claim 1, wherein the refractive film is a birefringent film.

5. The liquid crystal display device as claimed in claim 1, wherein the refractive film is a simple-refraction film.

6. A liquid crystal display device, comprising:
a first polarization plate having a first absorption axis;
a first birefringent film being provided atop the first polarization plate and having a slow axis;
a refractive film being provided atop the first birefringent film and having a slow axis;
an optically compensated bend mode (OCB-mode) cell being provided atop the refractive film and having an alignment direction, and the alignment direction of the OCB-mode cell and the slow axis of the refractive film being orthogonal to each other;
a second birefringent film being provided atop the OCB-mode cell and having a slow axis, and the slow axis of the second birefringent film and the slow axis of the first birefringent film being orthogonal to each other; and
a second polarization plate being provided atop the second birefringent film and having a second absorption axis, and the second absorption axis of the second polarization plate and the first absorption axis of the first polarization plate being orthogonal to each other.

7. The liquid crystal display device as claimed in claim 6, wherein the first birefringent film, the second birefringent film, and the refractive film respectively have an in-plane phase-difference value R_{O} ranged between 10 nm and 110 nm.

8. The liquid crystal display device as claimed in claim 6, wherein the first birefringent film, the second birefringent film, and the refractive film respectively have a thickness-direction phase-difference value Rₜₕ ranged between 100 nm and 250 nm.

9. The liquid crystal display device as claimed in claim 6, wherein the refractive film is a birefringent film.

10. The liquid crystal display device as claimed in claim 6, wherein the refractive film is a simple-refraction film.
